(19) United States
(12) Patent Application Publication
(10) Pub. No.: US 2008/0129709 A1
(43) Pub. Date: Jun. 5, 2008

(54) Electromagnetic Pen With Amplitude-Controlled Inking Function

(76) Inventors: Chun-Lin Lin, Hsinchu Science Park (TW); Chia-Te Huang, Hsinchu Science Park (TW)

Correspondence Address: LIN & ASSOCIATES INTELLECTUAL PROPERTY, INC., P.O. BOX 2339, SARATOGA, CA, 95070-0339, US

(21) Appl. No.: 11/565,630

(22) Filed: Dec. 1, 2006

(51) Int. Cl. G06F 3/033

(52) U.S. Cl. 345/179

(57) ABSTRACT

An electromagnetic pen with an amplitude-controlled inking function is provided, including a DC voltage source with a high voltage output source and a low voltage output source, a pen tip switch and a programmable LC circuit. The electromagnetic pen outputs an electromagnetic signal. The pen tip switch requires only a small amount of pressure to switch to high voltage output source and trigger the output electromagnetic signal so that the user feel comfortable in writing. The writing and drawing of the electromagnetic pen is controlled by the amplitude of the output electromagnetic signal, which corresponds to the pen tip pressure.

### FIELD OF THE INVENTION

The present invention generally relates to an electromagnetic pen with amplitude-controlled inking function, and more particularly to an electromagnetic pen using amplitude to control the writing and drawing mode.

### BACKGROUND OF THE INVENTION

The conventional electromagnetic pen usually uses a programmable LC circuit, which emits electromagnetic signal of a specific base frequency to indicate pen location when the pen hovering over a receiving device, say, a digitizer. The receiving device receives the electromagnetic signal and sends out a hovering signal to a host computer through a certain wired or wireless link, so that the host computer knows where the pointer is now.

When a vertical force is applied to the pen tip, the programmable LC circuit emits electromagnetic signal of a different frequency. The receiving device receives the electromagnetic signal and sends out an inking signal with pressure according to the frequency of the signal through a certain wired or wireless link to a host computer.

FIG. 1 shows a schematic view of a functional block diagram of a conventional electromagnetic pen. The programmable LC circuit generates the electromagnetic signal with specific frequency according to the pressure that the pen tip senses. Generally the frequency of the emitting electromagnetic signal is positively related to or negatively related to the pressure sensed. For a pressure over a threshold, the receiving tablet sends out an inking signal with pressure information; for a pressure under a threshold or even zero, the receiving tablet sends out a hovering signal without pressure information. Because of the manufacturing variance in the inductor and the capacitor in the programmable LC circuit, the frequency is not always accurate. Therefore, the frequency threshold to switch on pen inking should not be designed too close to the base frequency in order to avoid the misjudgment of whether inking or not.

The conventional electromagnetic pen needs a vertical pressure over the threshold applied to the pen tip to switch on inking function. However, this implies that the user must continuously apply a vertical pressure over the threshold to keep the pen in the inking state, which is inconvenient and make the writing process awkward.

Therefore, it is necessary to develop an electromagnetic pen to address the above problem. The user of the electromagnetic pen in question should be able to write by applying only a smaller amount of pressure, which makes the writing with the electromagnetic pen more smooth and convenient.

### SUMMARY OF THE INVENTION

The present invention has been made to overcome the above-mentioned drawback of conventional electromagnetic pen requiring a considerable amount of vertical pressure. The primary object of the present invention is to provide an electromagnetic pen with amplitude-controlled inking function that requires only a small mount of movement in the pen tip to write. In other words, a small amount of pressure applied can activate the electromagnetic pen for writing so as to improve the overall writing experience.

To achieve the above object, the present invention provides an electromagnetic pen, including a selectable high/low voltage DC source, a pen tip switch, and a programmable LC circuit. The LC circuit outputs an electromagnetic signal.

The pen tip switch selects the high voltage or the low voltage DC source in accordance with the pen tip pressure. When the vertical pressure is over the threshold, the tip switch selects the high voltage DC; otherwise it selects the low voltage DC as DC source for the LC circuit. Through the LC circuit, the high voltage DC source results in a large amplitude of electromagnetic signal while the low results in a small amplitude of electromagnetic signal. The amplitude of the emitting electromagnetic signal hence carries the information for controlling the ON/OFF of inking. In summary the emitting electromagnetic signal of the pen carries information both in its amplitude and in its frequency. The amplitude is either high or low. The high amplitude signal indicates that the pen tip pressure is above the threshold for ON so that the electromagnetic pen can write or draw on the receiving device. The low amplitude signal indicates that the pen tip pressure is below the threshold, and thus the pen is not used for writing but for locating the pointer. With the pen tip pressure increasing, the frequency of the output signal changes so that the digital tablet senses the change and sends pressure information to host computer, and then the application acts accordingly, for example, displays different line width, according to the received pressure information.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a functional block diagram of a conventional electromagnetic pen;

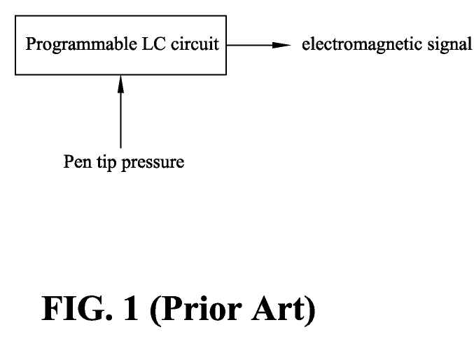

FIG. 2 shows a schematic view of a functional block diagram of an electromagnetic pen of the present invention; and

FIG. 3 shows a waveform of the electromagnetic pen of FIG. 2.

### DETAILED DESCRIPTION OF THE PREFERRED EMBODIMENTS

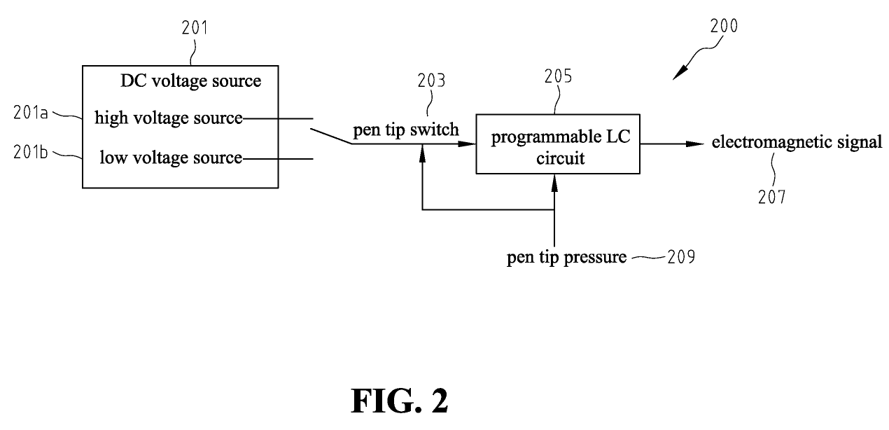

FIG. 2 shows a schematic view of the functional circuit block diagram of an electromagnetic pen of the present invention. A circuit 200 includes a DC voltage source 201 with a high voltage source 201a and a low voltage source 201b, a pen tip switch 203, and a programmable LC circuit 205. Pen tip switch 203 receives a pen tip pressure 209, and accordingly pen tip switch 203 determines whether to adopt high voltage source 201a or low voltage source 201b from DC voltage source 201, for DC voltage input of the LC circuit.

Pen tip switch 203 of the present invention can be a pressure-sensitive switch, a spring switch, a conductive rubber switch, or a membrane switch.

Pen tip switch 203 passes the determined DC voltage to programmable LC circuit 205. Programmable LC circuit 205 receives DC source from pen tip switch 203 and pen tip pressure 209, and outputs an electromagnetic signal 207 carrying information in both amplitude and frequency.

Electromagnetic signal 207 outputted from circuit 200 has only two possible amplitudes, high and low, which correspond to the inking and hovering mode of the electromagnetic pen.

In summary of the above description, when the pen tip of the electromagnetic pen hovering within a sensitivity range over a receiving device, such as a digital tablet, without actually touching the receiving device, pen tip pressure 209 does not reach the threshold. Therefore, pen tip switch 203 switches to low voltage DC source 201b, and makes programmable LC circuit 205 to emit output signal 207 with a low amplitude to the receiving device. When the pen tip slightly touches the receiving device, pen tip pressure 209 reaches the threshold and pen tip switch 203 switches to high voltage DC source 201a, and makes the programmable LC circuit 205 to emit output signal 207 with a high amplitude to the receiving device.

If, after reaching the threshold, pen tip pressure 209 continues to increase, programmable LC circuit 205 outputs signal 207 with a constant high amplitude and a decreasing or increasing frequency (depending on the circuit design) to the receiving device.

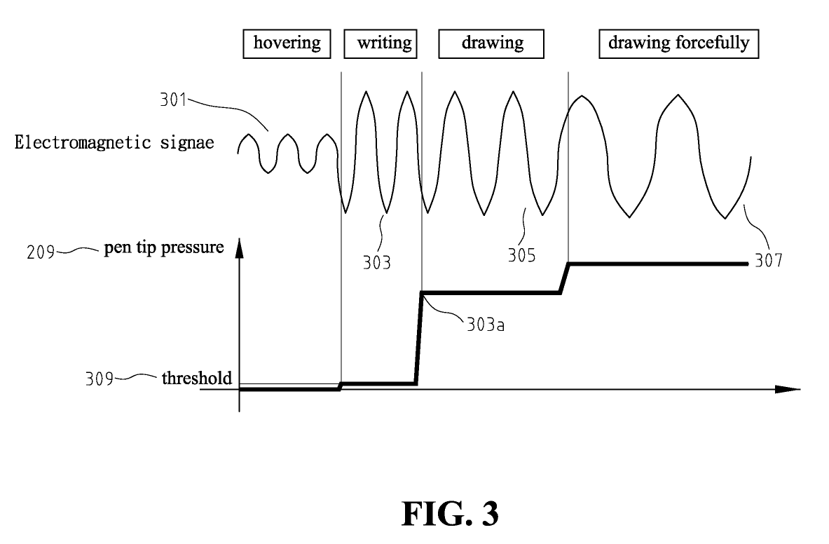

FIG. 3 shows a waveform of the embodiment of FIG. 2. As shown in FIG. 3, when the electromagnetic pen hovers over a digital tablet without touching the receiving device, pen tip pressure 209 is below writing threshold 309, pen tip switch 203 switches to low voltage DC source 201b, and the electromagnetic pen outputs a low amplitude signal, shown as 301 of FIG. 3. Threshold 309 of pen tip pressure 209 is designed to avoid the electromagnetic pen leakage, which is a situation when the pen tip is not pressed, but the receiving device misjudges that the pen tip is pressed.

When the pen tip slightly touches the receiving device, and pen tip pressure 209 reaches threshold 309, pen tip switch 203 switches to high voltage DC source 201a and the electromagnetic pen outputs a high amplitude signal, shown as 303 of FIG. 3. That is, the user can write by slightly touching the receiving device with the pen tip. If the user continues to increase the pressure to the pen tip to reach 303a, the pen outputs high amplitude, increasing/decreasing frequency signals 305, 307 to the receiving device, and the receiving device sends out pressure information to the host computer so that the related application displays different line widths.

In summary of the above description, when pen tip pressure 209 of the electromagnetic pen reaches threshold 309, the output signal changes from low amplitude to high amplitude so that the electromagnetic pen can write or draw on the receiving device. As pen tip pressure 209 changes, the frequency of the output signal also changes, which can inform the receiving device to send out pressure information.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An electromagnetic pen with amplitude-controlled inking function, comprising:
a DC voltage source, with a high voltage output source and a low voltage output source;
a pen tip switch, for receiving a pen tip pressure to determine whether to switch to receive said high voltage output source or said low voltage output source from said DC voltage source; and
an LC circuit, connected to said pen tip switch and said pen tip pressure to determine an output electromagnetic signal.

2. The electromagnetic pen as claimed in claim 1, wherein said pen tip switch switches to said high voltage output source when said pen tip pressure reaches a threshold.

3. The electromagnetic pen as claimed in claim 1, wherein said pen tip switch switches to said low voltage output source when said pen tip pressure does not reach a threshold.

4. The electromagnetic pen as claimed in claim 1, wherein said output electromagnetic signal is transmitted to a receiving device.

5. The electromagnetic pen as claimed in claim 4, wherein said amplitude of said output electromagnetic signal is for said receiving device to determine whether said threshold is reached.

6. The electromagnetic pen as claimed in claim 5, wherein said output electromagnetic signal from said electromagnetic pen enables said receiving device to determine said threshold is reached when said pen tip switch switches to said high voltage output source of said DC voltage source.

7. The electromagnetic pen as claimed in claim 5, wherein said output electromagnetic signal from said electromagnetic pen enables said receiving device to determine said threshold is not reached when said pen tip switch switches to said low voltage output source of said DC voltage source.

8. The electromagnetic pen as claimed in claim 1, wherein said pen tip switch is a pressure-sensitive switch, a spring switch, a conductive rubber switch, or a membrane switch

9. The electromagnetic pen as claimed in claim 1, wherein said LC circuit is a programmable LC circuit.
